(19) United States
(12) Patent Application Publication
(10) Pub. No.: US 2003/0024991 A1
(43) Pub. Date: Feb. 6, 2003

(54) Portable device for scanning documents integrated with a remote server

(76) Inventor: Raja Tuli, Montreal (CA)

Correspondence Address: Raja Singh Tuli, 555 Rene Levesque West, Suite 1130, Montreal,, QC, H2Z1B1, CA

(21) Appl. No.: 09/921,574

(22) Filed: Aug. 6, 2001

(51) Int. Cl. G06K 7/10

(52) U.S. Cl. 235/472.01

(57) ABSTRACT

The invention discloses a portable scanning device that stores locally in an internal memory scanned information. The device provides a means of collecting data or information and stores said information in an internal memory. The stored information can be transmitted to a remote server by connecting the device to a cellular telephone, or it may be transmitted wirelessly directly from the device. The memory is erased once the data has been transferred. Subsequently, the server sends the received data to the user's Web address or email address.

### PRIOR ART

The present invention relates to portable and hand-held document and image scanners. Hand-held scanners are manually moved across a document to be scanned such that an image of the face of the document is produced. Hand-held scanners such as those disclosed in U.S. Pat. No. 5,552,597 Hand-Held Scanner having Adjustable Light Path and U.S. Pat. No. 5,586,212 Optical Wave Guide for Hand-Held Scanner, by McConica, are examples of such scanning devices. The present invention discloses a hand-held scanner integrated with a remote server. Stored data in the device is transmitted to the remote server and the server then sends the received data to a specified Web address or email address.

### SUMMARY OF THE INVENTION

The invention discloses a portable scanning device that is capable of storing scanned information locally, and which information can be transmitted to a server via a cellular telephone, or wirelessly. The invention furnishes a unique function to users by providing a convenient and efficient method for users to organize collected information while away from their office or home.

### BRIEF DESCRIPTION OF THE DRAWINGS

FIG. 1 depicts the portable scanning device

FIG. 2 depicts the 2 inch device with ring

FIG. 3 shows the internal scanning mechanisms

FIG. 4 shows the switch for selecting a category

FIG. 5 shows the categories displayed on the LCD screen and buttons

FIG. 6 illustrates the device with a cover

FIG. 7 illustrates the device with rollers

FIG. 8 shows the device connected to a wireless telephone and server

### PREFERRED EMBODIMENT OF THE PRESENT INVENTION

The invention discloses a portable, optical scanning device that is capable of storing scanned information locally, and which device can be connected to a cellular telephone to transmit said stored information to a remote server for storage and organization. Thus, the connection of the device to the server provides a unique function for a user, for example a business traveler, in that the user can utilize the device to scan collected information, for example business cards, which information can be stored locally in the device. The stored information can then be transmitted to a remote server for classification. The essence of the invention lies in the integration of the device and the server that together provide a convenient and efficient method for users to organize collected information while away from their office or home.

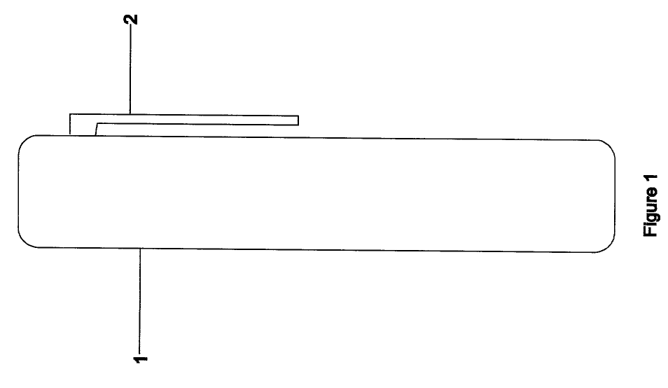

The portable device will now be described in relation to the accompanying drawings. With reference to FIG. 1, an illustration of the device 1 is shown. The device is substantially round, compact and lightweight so as to be easily manipulated by the user, and houses a plurality of scanning mechanisms necessary for a contact image sensor type scanner. A clip 2 is displayed which is closed at a superior end 3, and open at an opposite end 4. The open end enables the user to straddle the device onto a pocket attached to clothing. Thus, the device is easily portable and may be securely carried anywhere.

The length of the device is approximately the width of a standard sheet of paper. A standard sheet of paper is defined as having dimensions of 8½×11 inches, thus the device is approximately 8½ inches long. The length is the largest dimension of the device and the clip lies parallel to the length.

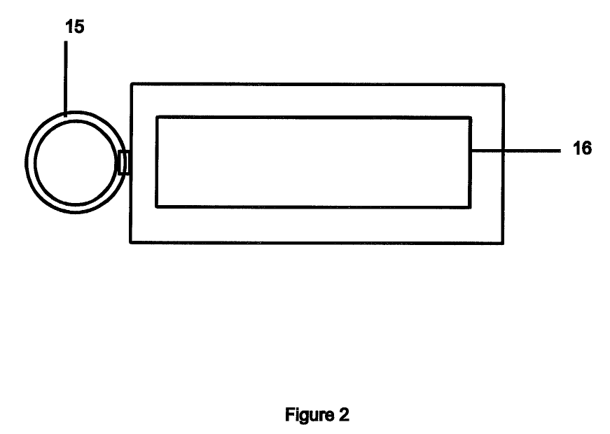

In the preferred embodiment of the present invention, the length of the device may be approximately two inches long, as shown in FIG. 2. The device is further equipped with a ring 15 mounted to an end, and which ring may be used for carrying keys. Thus, the device can be utilized as a key chain, further enhancing its practicality. The device further comprises an LCD screen 16 for displaying recently scanned documents, or documents that have been stored in the memory.

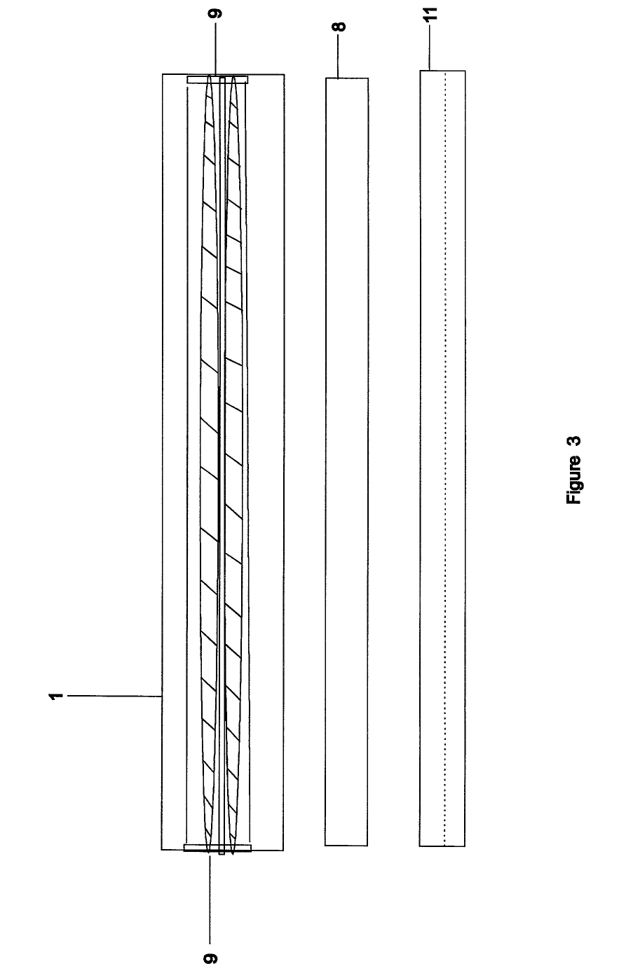

Referring to FIG. 3, solid state devices are arranged along the length of the device such that the entire length of a line of a page may be read and converted to a digital image.

FIG. 3 illustrates a cross-section of the device. A linear array of light-emitting diodes (LEDs) 8 serve as an illumination source which send rays of light through a light guide 9 that focuses the light onto the surface of a document to be read. The LEDs and the light guide span the entire reading length of the device. The illuminated portion of the document is reflected and focussed by an optic fiber lens array 11 onto an optical sensor array. The optical sensor array consists of one or more solid state devices comprising multiple individual photo cells in a linear array, which convert the image focussed onto them into electrical signals, producing a digital image which can be stored in an internal memory for future use. The stored data may be downloaded into a computer or laptop at a later time. The LEDs and the lens array must be arranged with the illuminated surface of the document to ensure proper focussing of the image on the solid state reading devices. The solid state devices are capable of reading one line of information at a time restricted by the size, spacing and width spanned by the individual photocells in the linear array. Each line of information is read multiple times with 200 or 400 dpi but sent only once to a microprocessor in the device which assembles the image received in lines, and also performs image enhancement techniques to produce a true representation of the image or text being read. The solid state devices read the lines of information continuously, to form a 2-D image.

The user must create a profile on the remote server, which profile includes the user's electronic mail address (e-mail) and a user identification and any other required pertinent information. The user can access the server via a desktop computer or a laptop computer or any other device with which the user can access the Internet.

Moreover, the user can store files and documents directly on the server, therefore the user can also enter a password for accessing the stored documents at a later time.

In the preferred embodiment of the invention, the device is utilized as a means of collecting data that an individual, for example a business traveler, accumulates on a trip. For example, Internet Web site addresses, such as those printed in magazines or newspapers that are of interest to the individual can be scanned easily and quickly with the device. Thus, the user does not have to try to remember these addresses or file away pieces of paper printed with the addresses that will doubtlessly get lost. The device can also be used for scanning business cards that have been collected at meetings or conferences, and the device can also be utilized for scanning receipts.

The user can program the device with categories appropriate to the user's requirements. The device enables users to personalize the device to their owns needs.

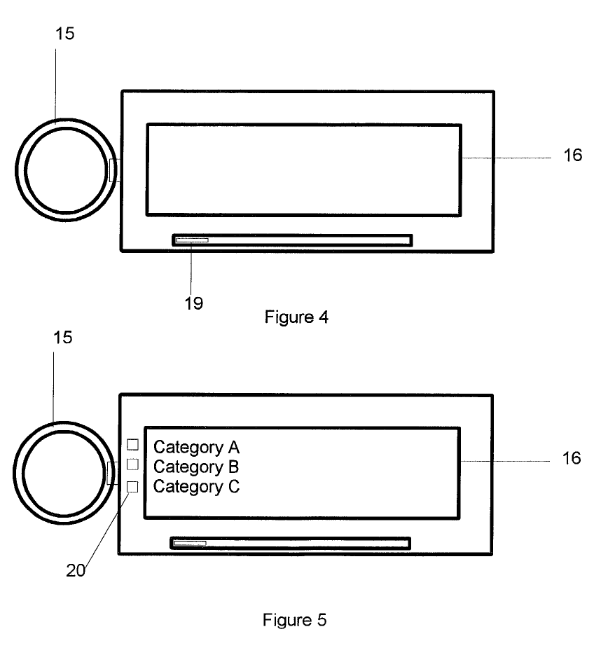

Categorization of the scanned documents and information is accomplished by means of a switch 19 mounted to the exterior of the housing, as shown in FIG. 4. The switch can be advanced to the appropriate category—business cards, receipts, or Web addresses—depending upon the type of information that the user has scanned. Thus, the user slides the switch to “business cards” if a business card is to be scanned. Or, the user can slide the switch to “expenses” if a receipt is to be scanned. Upon a particular document being scanned, the device “tags” the scanned document with an appropriate extension. For example, a business card is allocated a particular extension, different from the extension of a receipt. To ensure that a scanned document is categorized properly, the user must select the appropriate category that is related to the document to be scanned prior to scanning said document.

Alternately, the categories can be displayed on the LCD screen 16, as shown in FIG. 5. The user can select the appropriate category by means of a button 20 mounted adjacent to the screen. In another embodiment, the buttons may be displayed directly on the screen. In another embodiment, the buttons provide scrolling functions, either up or down, in order for the user to scroll through a scanned document or to the select the appropriate category.

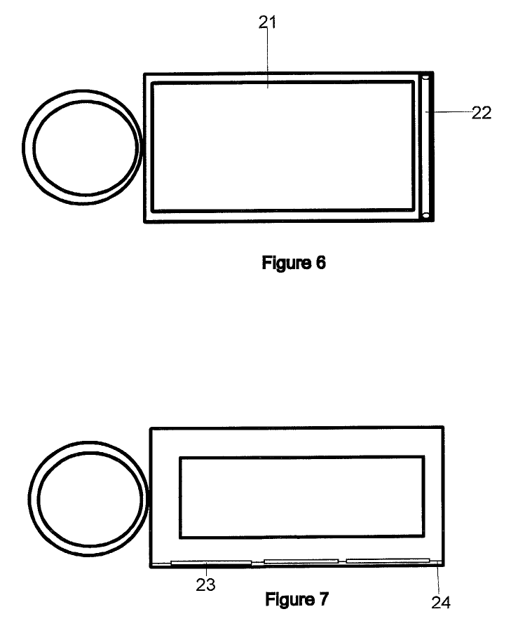

In the preferred embodiment of the invention, the device comprises a cover 21 mounted to the device via conventional hinges 22, as shown in FIG. 6. The hinges allow the user to open and close the cover, and the procedure of opening the cover activates the device. Once the device has been activated the user can subsequently select the appropriate category, and then scan the document. Selection of the appropriate category is accomplished by means of a switch mounted to the exterior of the housing. The switch can be advanced to the appropriate category—business cards, receipts, or Web addresses—depending upon the type of information that the user has scanned. Thus, the user slides the switch to “business cards” if a business card is to be scanned. Or, the user can slide the switch to “expenses” if a receipt is to be scanned. Upon a particular document being scanned, the device “tags” the scanned document with an appropriate extension. For example, a business card is allocated a particular extension, different from the extension of a receipt. To ensure that a scanned document is categorized properly, the user must select the appropriate category that is related to the document to be scanned prior to scanning said document.

Alternately, the categories can be displayed on the LCD screen. The user can select the appropriate category by means of a button mounted adjacent to the screen. In another embodiment, the buttons may be displayed directly on the screen. In another embodiment, the buttons provide scrolling functions, either up or down, in order for the user to scroll through a scanned document or to the select the appropriate category.

In another embodiment of the invention, the device is activated by the rotation of a single or multiple rollers 23 mounted to the device, as shown in FIG. 7. The rollers are arranged along a single shaft 24 and are separated. The surface of the document to be read adheres to the rollers' rubber segments, thereby preventing skewing of the image, providing an image alignment feature. The rollers also prevent the document from slipping or shifting during the scanning procedure that would cause image errors. The rubber rollers rotate against the document as the pen is manually traversed, by pressing the pen against the surface of a document. The user selects the appropriate category prior to traversing the device across the document. Selection of the appropriate category is accomplished by means of a switch mounted to the exterior of the housing. The switch can be advanced to the appropriate category—business cards, receipts, or Web addresses—depending upon the type of information that the user has scanned. Thus, the user slides the switch to “business cards” if a business card is to be scanned. Or, the user can slide the switch to “expenses” if a receipt is to be scanned. Upon a particular document being scanned, the device “tags” the scanned document with an appropriate extension. For example, a business card is allocated a particular extension, different from the extension of a receipt. To ensure that a scanned document is categorized properly, the user must select the appropriate category that is related to the document to be scanned prior to scanning said document.

Alternately, the categories can be displayed on the LCD screen. The user can select the appropriate category by means of a button mounted adjacent to the screen. In another embodiment, the buttons may be displayed directly on the screen. In another embodiment, the buttons provide scrolling functions, either up or down, in order for the user to scroll through a scanned document or to the select the appropriate category.

In another embodiment, the user must first choose the appropriate category from the list displayed on the LCD screen. Selection of the appropriate category is accomplished by means of a switch mounted to the exterior of the housing. The switch can be advanced to the appropriate category—business cards, receipts, or Web addresses—depending upon the type of information that the user has scanned. Thus, the user slides the switch to “business cards” if a business card is to be scanned. Or, the user can slide the switch to “expenses” if a receipt is to be scanned. Upon a particular document being scanned, the device “tags” the scanned document with an appropriate extension. For example, a business card is allocated a particular extension, different from the extension of a receipt. To ensure that a scanned document is categorized properly, the user must select the appropriate category that is related to the document to be scanned prior to scanning said document.

Alternately, the categories can be displayed on the LCD screen. The user can select the appropriate category by means of a button mounted adjacent to the screen. In another embodiment, the buttons may be displayed directly on the screen. In another embodiment, the buttons provide scrolling functions, either up or down, in order for the user to scroll through a scanned document or to the select the appropriate category. The user can then open the cover of the device, thereby activating the device, and the user can then scan the document.

Implementation of the device requires that the user position the device flat across the document to be read and manually traverse the device in the desired direction. The solid state elements read the full width of each line as the device is traversed. The user must hold the device flat against the surface of the document such that the document is pressed against the glass.

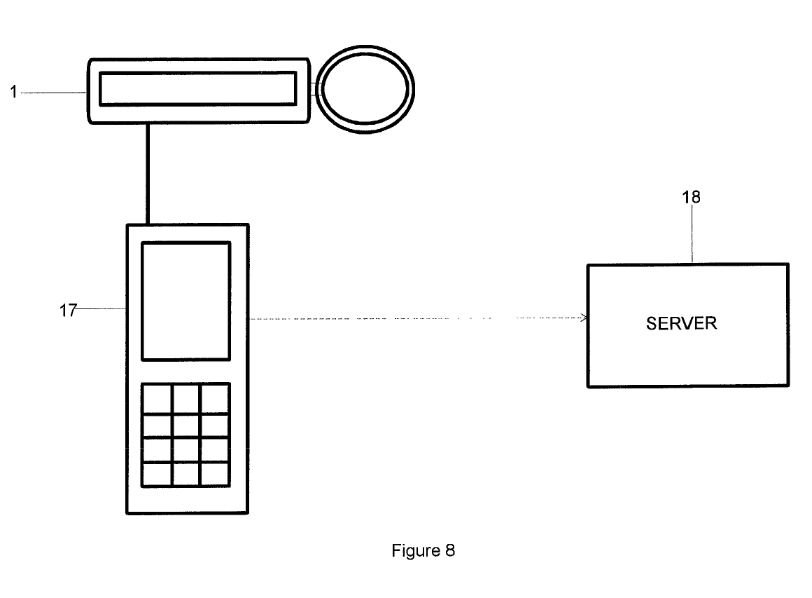

With reference to FIG. 8, the user can connect the device 1 to a cellular telephone 17 to transmit the stored Web addresses to a remote server 18. The number to access the Internet and the user's identification are stored in the device. Thus, upon the user connecting the cellular telephone to the device the number to access the Internet is automatically dialed. Upon connection to the server, the device supplies the user's identification and subsequently the stored information is sent to the server. The memory of the device is erased once all of the stored data has been transferred to the server. The server can store the transferred files, which the user can access at a later time by providing the user identification and password.

The device stamps each scanned document with the date and time the scanning occurred.

It is possible for the server to transmit the received files to the email address of the user, and the user can access the email at a later time, in order to view the data that had been collected.

Alternately, the device can connect wirelessly to the server. Comprised in the device is a pager system to enable the device to act as a conventional pager. Thus, the device can connect wirelessly to a low band width network to transfer stored data to the server. However, because the transfer rate of the network is low, and therefore slow, it is preferable that the stored data is transferred at specific, less busy times and in bursts of information to the server. The device can be programmed to transfer stored data at predetermined times preferably when the network would not be busy, thereby increasing the speed of transfer. For example, late at night or early in the morning would be possible times for transferring data because the network would be less busy.

Alternately, when the network has sufficient bandwidth to transfer the stored data, the network can access the device and execute the transfer accordingly. If numerous files are to be transferred to the server, only a portion of the files will be transferred because of the low bandwidth of the network. The device tags the files that have been sent, thus when the user checks the device to verify that files have been transferred the user knows the tagged files have been sent. The user's identification is stored in the device as well as the number for accessing the Internet. Thus, as soon as the device gains access to the wireless network the number for the Internet is dialed and the user's identification is transmitted. The information stored in the device's memory is transmitted to the server, and the server then sends the received information to the user's email address, or stores the information on the server What is claimed;

1. A portable scanning device capable of storing locally scanned information and allowing the user through the user's input to categorize the locally scanned information.

2. A device as claimed in claim 1, which a user can connect through a wireless network wherein the device contains information to contact the server.

3. A device as claimed in claim 1, such that the device contains a screen that allows display of information selected through categories by the user.

4. A device as claimed in claim 1 that tags all scanned information with appropriate extensions such that the server can distinguish the type of file that is being transmitted.
